(19) United States
(12) Patent Application Publication
(10) Pub. No.: US 2013/0022796 A1
(43) Pub. Date: Jan. 24, 2013

(54) ELASTIC FABRIC WITH ADHESIVE

(71) Applicants: Tianyi Liao, Chadds Ford, PA (US); Carmen Covelli, Chadds Ford, PA (US); Hong Liu, Waynesboro, VA (US); Douglas K. Farmer, Greensboro, NC (US); Fred C. Wynegar, Wilmington, DE (US)

(72) Inventors: Tianyi Liao, Chadds Ford, PA (US); Carmen Covelli, Chadds Ford, PA (US); Hong Liu, Waynesboro, VA (US); Douglas K. Farmer, Greensboro, NC (US); Fred C. Wynegar, Wilmington, DE (US)

(73) Assignee: Three Little Falls Centre, Wilmington, DE (US)

(21) Appl. No.: 13/510,044

(22) PCT Filed: Nov. 5, 2010
(86) PCT No.: PCT/US10/55559

§ 371 Date: Jun. 22, 2012

Related U.S. Application Data
(60) Provisional application No. 61/261,594, filed on Nov. 16, 2009.

(51) Int. Cl. B32B 7/12; B32B 5/26; B32B 5/18; C09J 7/04

(52) U.S. Cl. 428/196; 442/149; 442/150; 442/151; 428/221; 428/317.1; 428/316.6

(57) ABSTRACT

Included are elastic laminate articles that include multiple layers. This includes one stretch fabric comprising about 50% to 100% elastic fibers by weight of the fabric, including fabrics that include 100% elastic fibers and at least one adhesive.

### CROSS-REFERENCE TO RELATED APPLICATION

This application claims benefit of priority from U.S. Provisional Application No. 61/261594 filed Nov. 16, 2009.

### BACKGROUND OF THE INVENTION

1. Field of the Invention

The present invention relates an article including an elastomeric fabric including primarily elastomeric fibers in combination with an adhesive. Where the adhesive is coated on the elastomeric fabric, the article is essentially an elastic film. The articles can be bonded or attached to other fabrics that may optionally be elastic fabrics. Methods of making the articles are also included.

2. Summary of Related Technology

Various polymers such as polyamides, polyolefins, and polyurethanes (including polyurethaneureas) can be used as adhesives for various substrates, including textile fabrics. Examples of films include thermoplastic polyurethane, polyamide, and polyolefin films commercially available from Bemis Associates, Shirley, Mass. Examples of polyurethane films which are cast and dried from an aqueous polyurethane dispersion are disclosed in U.S. Pat. No. 7,240,371 and U.S. Patent Application Publication No. 2008/0004395A1; both of which are incorporated herein by reference in their entirety.

Traditional adhesives are not air permeable. Within the areas bonded with adhesive film, the garment is not breathable, which results in a hot and uncomfortable feeling for the wearer of such a garment. In order to obtain adequate strength and bond force, many films are made with greater thickness which can result in unfavorably stiff and harsh fabrics and garments.

The wash durability of the film as bonded in a garment is an issue for garments that will endure repeated household and/or commercial laundering. Currently, in order to achieve a durable bond, high bonding temperature and long duration is necessary.

### SUMMARY OF THE INVENTION

Bondable elastic films of some aspects can provide a reduction in bonding temperature and bonding time. This translates to a reduction in the amount of energy, production time, and the likelihood of damaging fine fabrics.

The article of some aspects includes at least one heat-activated adhesive, such as an adhesive polymer, and an elastic fabric including about 50% or greater elastomeric fibers based on the weight of the fabric, including up to about 100% elastomeric fibers. The elastic fabrics provide excellent recovery power and shape retention ability, while the adhesive provides strong bonding force. The adhesive is selected from the group consisting of polyurethanes, polyolefins, polyamides, polyesters and combinations thereof. The addition of the elastic fabric to the film allows an increase of the strength and softness of the film. The fabric/adhesive article also can provide breathability otherwise unattainable for films.

The combination of the elastic fabric with adhesive makes the stretch and recovery performance of adhesive less important; thus broadening the options for selecting an appropriate adhesive. This is due the improved recovery power of the elastic fabric in comparison to a conventional film which would provide both recovery power and adhesiveness. Therefore, the articles of some aspects provide a high quality adhesive film with high recover power and high adhesive force can be produced. Due to many pores and holes between fibers within elastic fabric, bounding heat can be easier transformed. It is possible to bond the fabrics with higher efficiency, low temperature, shorter time and less damage to fabrics.

In another aspect the article includes an elastic fabric from about 50% to about 100% elastomeric fibers by weight of the fabric, such as 100% elastomeric fiber with no companion fiber. The fabric may have a construction selected from the group consisting of weft knit (such as circular knit), warp knit, wovens and nonwoven.

In a further embodiment is a method of making a substrate including:
(a) fabric with 100% elastic fibers, fusible fiber as a option;
(b) Adding adhesive polymers onto fabrics to form adhesive film;
(c) Bonding of adhesive film with garment fabrics.

### DETAILED DESCRIPTION OF THE INVENTION

Elastomeric fibers are commonly used to provide stretch and elastic recovery in fabrics and garments. “Elastomeric fibers” are either a continuous filament (optionally a coalesced multifilament) or a plurality of filaments, free of diluents, which have a break elongation in excess of 100% independent of any crimp. An elastomeric fiber when (1) stretched to twice its length; (2) held for one minute; and (3) released, retracts to less than 1.5 times its original length within one minute of being released. As used in the text of this specification, “elastomeric fibers” means at least one elastomeric fiber or filament. Such elastomeric fibers include but are not limited to rubber filament, biconstituent filament (which may be based on rubber, polyurethane, etc.), lastol, and spandex. The terms “elastomeric” and “elastic” are used interchangeably throughout the specification.

“Spandex” is a manufactured filament in which the filament-forming substance is a long chain synthetic polymer comprised of at least 85% by weight of segmented polyurethane.

“Elastoester” is a manufactured filament in which the fiber forming substance is a long chain synthetic polymer composed of at least 50% by weight of aliphatic polyether and at least 35% by weight of polyester. Although not elastomeric, elastoester may be included in some fabrics herein.

“Biconstituent filament” is a continuous filament comprising at least two polymers adhered to each other along the length of the filament, each polymer being in a different generic class, for example, an elastomeric polyetheramide core and a polyamide sheath with lobes or wings. Examples of biconstituent or bicomponent polyurethane (or spandex) fibers/filaments are disclosed in PCT/US09/60370, filed on Oct. 12, 2009 which is incorporated herein by reference in its entirety.

“Lastol” is a fiber of cross-linked synthetic polymer, with low but significant crystallinity, composed of at least 95 percent by weight of ethylene and at least one other olefin unit. This fiber is elastic and substantially heat resistant.

A “covered” elastomeric fiber is one surrounded by, twisted with, or intermingled with hard yarn. The covered yarn that comprises elastomeric fibers and hard yarns is also termed a “composite yarn” in the text of this specification. The hard-yarn covering serves to protect the elastomeric fibers from abrasion during weaving processes. Such abrasion can result in breaks in the elastomeric fiber with consequential process interruptions and undesired fabric non-uniformities. Further, the covering helps to stabilize the elastomeric fiber elastic behavior, so that the composite yarn elongation can be more uniformly controlled during weaving processes than would be possible with bare elastomeric fibers. The terms “elastic core yarn”, “elastic core end”, “core end” , “composite yarn”, “core yarn” and “composite elastic core yarn” are all used interchangeably throughout the specification.

The composite yarns include: (a) single wrapping of the elastomer fibers with a hard yarn; (b) double wrapping of the elastomer fibers with a hard yarn; (c) continuously covering (i.e., core-spinning) an elastomer fiber with staple fibers, followed by twisting during winding; (d) intermingling and entangling elastomer and hard yarns with an air jet; and (e) twisting an elastomer fibers and hard yarns together.

“Pressing” or “pressed” refers to an article that has been subjected to heat and/or pressure to provide a substantially planar structure.

“Dispersion” refers to a system in which the disperse phase consists of finely divided particles, and the continuous phase can be a liquid, solid or gas.

“Aqueous polyurethane dispersion” refers to a composition containing at least a polyurethane or polyurethane urea polymer or prepolymer (such as the polyurethane prepolymer described herein), optionally including a solvent, that has been dispersed in an aqueous medium, such as water, including de-ionized water.

“Solvent,” unless otherwise indicated, refers to a non-aqueous medium, wherein the non-aqueous medium includes organic solvents, including volatile organic solvents (such as acetone) and somewhat less volatile organic solvents (such as MEK, or NMP).

“Solvent-free” or “solvent-free system” refers to a composition or dispersion wherein the bulk of the composition or dispersed components has not been dissolved or dispersed in a solvent.

“Molded” article refers to a result by which the shape of an article or shaped article is changed in response to application of heat and/or pressure.

In some embodiments are multiple layer articles which include at least one layer of a stretch fabric with about 50% to 100% Elastomeric fibers which may be either a single elastomeric fiber or a combination of different elastomeric fibers, e.g. spandex and rubber fibers or spandex and lastol fibers. The elastomeric fabric may be present in an amount from about 50% by weight of the fabric to about 100% by weight of the fabric, including fabrics that include about 70% to 100%, about 80% to 100%, about 90% to 100%, and 95% to 100% (where each percent is the presence of the elastomeric fiber based on the total weight of the fabric).

The fabric may include only elastomeric fibers, i.e., 100% elastomeric. Alternatively, the elastomeric fibers in the fabric may be combined with one or more companion yarns. Where the elastic fabric includes one or more companion yarns (in addition to the elastomeric fiber), the companion yarn may be either a hard yarn which exhibits little stretch/recovery or an elastic fiber. Examples of hard yarns include yarns made from natural and synthetic fibers. Suitable natural fibers may be cotton or other cellulosic fibers, silk, or wool, among others. Synthetic fibers include nylon, polyester, among others. Blend of different fibers may also be included (blends may include different natural fibers, different synthetic fibers or both.

Examples of elastic fibers include polyester bicomponent fiber (available from INVISTA, Wichita, Kans. as LYCRA®T400® fiber), lastol, rubber, and polybutylene terephthalate (PBT). These fabrics may include the elastomeric fiber with a hard yarn. Alternatively, the fabric may include the elastomeric yarn with another elastic yarn.

“Fabric” refers to a knitted, woven or nonwoven material. The knitted fabric may be flat knit, circular knit, warp knit, narrow elastic, and lace. The woven fabric may be of any construction, for example sateen, twill, plain weave, oxford weave, basket weave, and narrow elastic. The nonwoven material may be meltblown, spun bonded, wet-laid, carded fiber-based staple webs, and the like.

The article also includes at least one layer of adhesive polymer. The adhesive could be in the form of a film, web, perforated sheet or dispersion. They stick with elastic fibers evenly. The elastic fabric may be placed adjacent to or between the adhesive layers and also may provide stretch and recovery, increased elastic modulus, moldability, shape retention, and flexibility properties for the article.

Adhesives other than polyurethane (including polyurethaneurea) dispersions or films may be included in the articles of some aspects in combination with an elastic fabric. Examples of adhesives include any hot melt adhesive, a cyanoacrylate, an epoxy, polyvinyl acetate, a plastisol (including rubber), a thermoplastic (including polyurethanes, polyesters, and polyamides), silicone, latex polymer, a thermoset, a pressure sensitive adhesive and combinations thereof.

The adhesive may be used to prepare the adhesive/elastic fabric composite article or to adhere the composite article to a fabric. An additional adhesive may optionally be included where the composite article is attached to a separate fabric or garment. The fabric or garment may include another fabric construction and may exclude an elastomeric fiber.

The adhesive may include a continuous or discontinuous application for either the elastic fabric/adhesive composite article or where the composite article is attached to a fabric or garment. Examples of discontinuous application of adhesive include the group consisting of dots, vertical lines, horizontal lines, diagonal lines, a grid, and combinations thereof.

An example of a commercially available hot melt adhesive in a dot configuration is available under the tradename Pinbond®, by Freudenberg Gygli GmbH, Weinheim, Germany and is useful for bonding elastic textiles. Moreover, the elastic fabric/adhesive composite article may also be used as an adhesive to adhere more than one layer of any the garment or polyurethaneurea film as described in some aspects.

A variety of different fibers and yarns may be used with the fabrics and garments of some aspects. These include cotton, wool, acrylic, polyamide (nylon), polyester, spandex, regenerated cellulose, rubber (natural or synthetic), bamboo, silk, soy or combinations thereof. Additional layers of fabric may be attached/bonded/etc. to the elastic fabric.

These articles may be formed into fabrics and/or garments by any suitable method. The adhesive in the composite article may be the form of attachment, but bonding or sewing may also be useful.

### ANALYTICAL METHOD

In the examples that follow, the following analytical methods were used.

Peel Strength for Adhesive Bonds

ASTM D903-93, the entire disclosure of which is incorporated herein by reference, was modified for testing of film laminated fabrics. The sample size used for testing was 1 inches×6 inches (2.5 cm×15 cm). The separation rate was 2 inches per minute (5 centimeter per minute). Data are reported as pounds of force per inch of sample width (kilogram per millimeter), as shown in the table.

### EXAMPLES

The table below describes some suitable elastic fabric/adhesive composite articles described in some aspects. The “LYCRA® type” category describes the LYCRA® fiber (available from INVSITA, Wichita, Kans.) used with each fabric which were prepared using 100% LYCRA® fiber. LYCRA® dispersion refers to the dispersion from which LYCRA® 2.0 tapes and films (available from INVSITA, Wichita, Kans.) are prepared.

| | | | | | | | | | | Peel |
|---|---|---|---|---|---|---|---|---|---|---|
| | LYCRA ® | LYCRA ® | Knit | Knit | | Implementation | Bonding | Bonding | Bonding | strength |
| Sample | Type | Denier | Structure | Machine | Resin Type | Method | fabrics | Termperature | Time | (lb./inch) |
| #1 | T162C | 40 | plain knit | Satony | LYCRA ® | dip | | | | |
| | | | | | dispersion | | | | | |
| #2 | T162C | 40 | plain knit | Satony | LYCRA ® | brush coat | stretch warp | 150 C. | 20 second | 2.98 |
| | | | | | dispersion | one time | knit | | | |
| #3 | T162C | 40 | plain knit | Satony | LYCRA ® | brush coat | stretch warp | 150 C. | 20 second | 4.89 |
| | | | | | dispersion | one time | knit | | | |
| #4 | No finish | 40 | single | Satony | LYCRA ® | roll | stretch warp | 150 C. | 20 second | |
| | LYCRA ® | | jersey | | dispersion | | knit | | | |
| #5 | T162C | 40 | single | Satony | Henkel | spread | stretch warp | 150 C. | 20 second | |
| | | | jersey | | adhesive 34 | | knit | | | |
| | | | | | 897B | | | | | |
| #6 | T162C | 40 | single | Satony | Bostik adhesive | spread | stretch warp | 150 C. | 20 second | |
| | | | jersey | | 2385 | | knit | | | |
| #7 | XA | 540 | single | leg knit | LYCRA ® | dip | stretch warp | 150 C. | 20 second | |
| | LYCRA ® | | jersey | | dispersion | | knit | | | |

1. An article comprising multiple layers comprising:
(a) one stretch fabrics comprising about 100% elastic fibers by weight of the fabric and
(b) at least one adhesive.

2. The article of claim 1, wherein said adhesive is a hot melt adhesive, a contact adhesive, a thermoplastic, or a polyurethaneurea aqueous dispersion. (include hot melt nonwoven and dot glue).

3. The article of claim 2, wherein said dispersion is substantially solvent free.

4. The article of claim 1, wherein the adhesive is mix of hot-melt polymers with an aqueous polyurethaneurea dispersion.

5. The article of claim 1, wherein said stretch fabric is circular knit, warp knit, wovens and/or nonwoven fabric.

6. The article of claim 1, wherein said elastic fiber is spandex.

7. The fabrics and garments that comprising the article of claim 1.

8. A method of making an article of claim 1.

9. A fabric comprising multiple layers comprising:
(a) at least two layers; and
(b) at least one article of claim 1.

10. The article of claim 9, wherein said at least two layers are selected from the group consisting of (a) two fabric layers, (b) two foam layers, (c) a fabric layer and a foam layer, and combinations thereof.

11. The article of claim 10, wherein the article is molded.

12. The article of claim 10, wherein the article is pressed.

13. The article of claim 10, wherein the article of claim 1 extends throughout the entire area of the multiple layer article.

14. The article of claim 10, wherein the article of claim 1 extends to a portion of the area of the multiple layer article.

15. An article comprising multiple layers comprising:
(a) one stretch fabric comprising about 50% to 100% elastic fibers by weight of the fabric and
(b) at least one adhesive.

16. The article of claim 15, wherein the elastic fibers are present from 95% to about 100% by weight of the fabric.

17. The article of claim 15, wherein the stretch fabric consists essentially of one or more elastic fibers.
